(19) United States
(12) Patent Application Publication
(10) Pub. No.: US 2015/0261066 A1
(43) Pub. Date: Sep. 17, 2015

(54) FILTER ASSEMBLY WITH HANDLE MECHANISM

(71) Applicant: NICHOLAS WONG, Burien, WA (US)

(72) Inventor: NICHOLAS WONG, Burien, WA (US)

(21) Appl. No.: 14/205,314

(22) Filed: Mar. 11, 2014

(51) Int. Cl. G03B 11/00; G02B 5/04; G02B 7/00

(52) U.S. Cl. CPC G03B 11/00; G02B 7/006; G02B 5/045

(57) ABSTRACT

An optical apparatus for photographic or videographic uses may include an optical lens configured to affect light passing therethrough. The optical apparatus may also include a handle mechanism attached to the filter and configured to be held by a user to position the filter in front of a camera lens.

### BACKGROUND

1. Field

This present disclosure relates to the field of optical filters for photographic and videographic creation. These filters may be placed in front of the exterior-facing element of a photographic or videographic lens.

2. Description of the Related Art

There are many known devices used today as filters to be placed in front of the exterior-facing element of a photographic or videographic lens. The purpose of these filters runs the gamut: from stopping or slowing down the light that enters the lens; to changing the color of light as it enters the lens; to achieving prismed optical effects achieved in the glass. These filters are typically screwed in to the exterior-facing element of a photographic or videographic lens, but in certain situations are supplemented with harnesses which allow the filters to sit in a fixed-position at a predetermined distance in front of the lens.

These filters are limiting to a large extent. Photographic and videographic filters generally house transparent glass which—much like most other polished glass—has reflective properties. By either being screwed onto the lens or by being stuck in a fixed position in front of the lens, the glass inside the filter limits the user to only providing a fixed optical effect.

The disclosed filter assembly is directed to overcoming one or more of the problems set forth above.

### SUMMARY

According to an aspect, a filter assembly for photographic and videographic purposes includes a housing apparatus, inside which a piece of glass sits.

### BRIEF DESCRIPTION OF THE VIEWS OF THE DRAWINGS

FIG. 1 is a front view showing a filter assembly according to an embodiment;

FIG. 2 is an exploded perspective view of the filter assembly of FIG. 1, showing a polarizing inner-ring separated from a main housing unit, and a glass filter further exploded from the polarizing inner-ring;

FIG. 3 is an exploded side view of the filter assembly of FIG. 1, showing the polarizing inner-ring separated from the main housing unit;

FIG. 4 is an exploded perspective view of the filter assembly of FIG. 1 with a mounting arm and a camera;

FIG. 5 is a side view of the filter assembly of FIG. 1 mounted to the mounting arm, which is mounted to the top of the camera; and

FIG. 6 is a side view of the filter assembly of FIG. 1 mounted to the mounting arm, which is mounted to the bottom of the camera.

### DETAILED DESCRIPTION

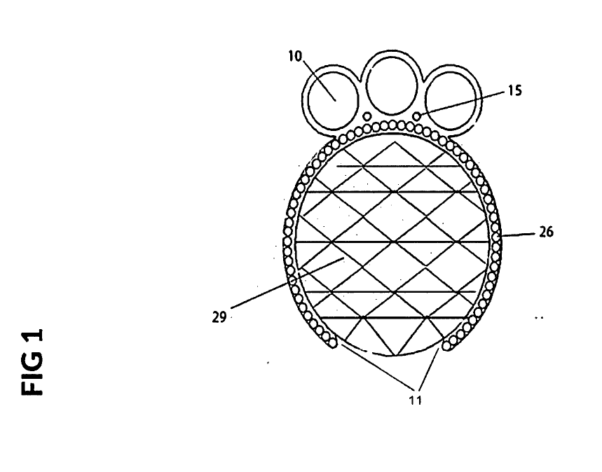

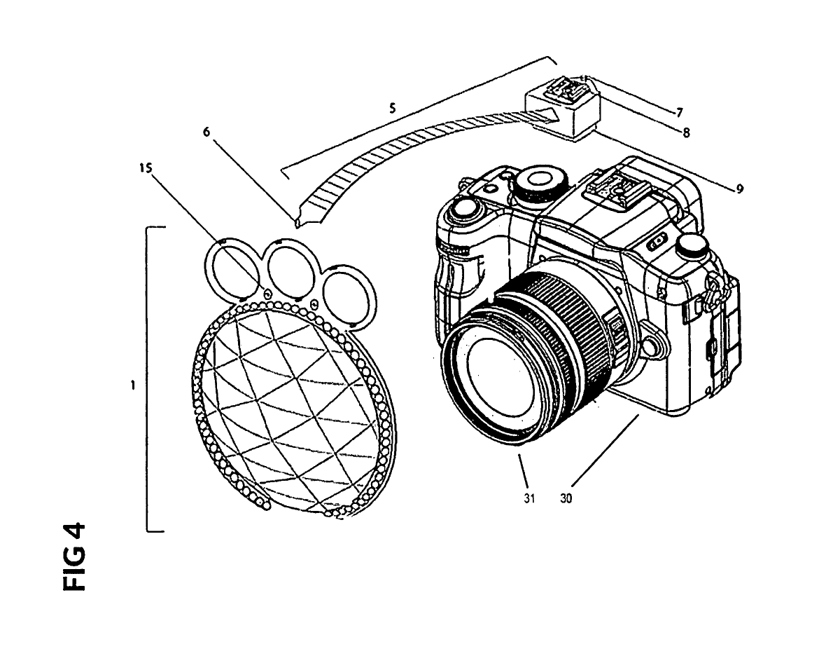

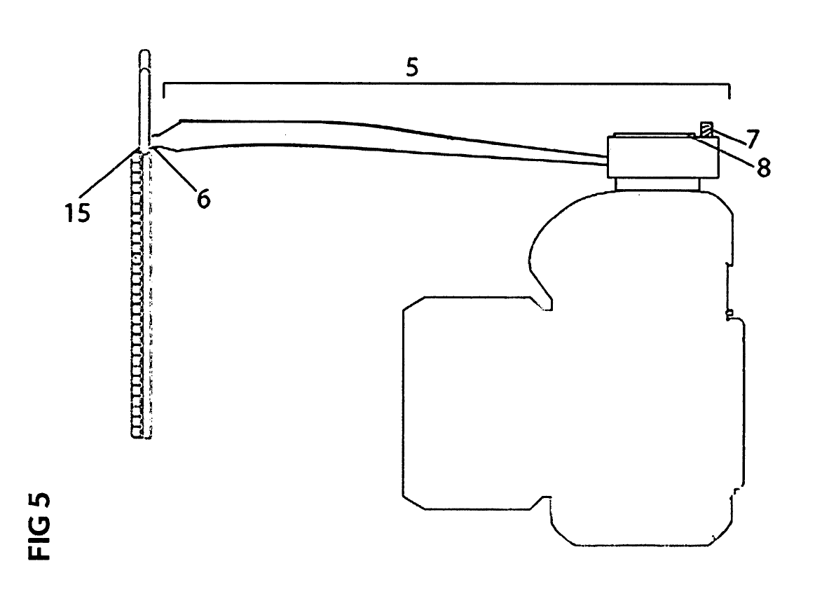

FIG. 1 shows a front view of an embodiment of the filter assembly 1 in an assembled state. The filter assembly 1 may include a main housing unit 21, a handle mechanism that attaches to or is integral with the main housing unit 21, and one or more mounting holes 15. The mounting holes 15 may to be provided to allow a user to mount the filter assembly 1 in a free position in front of a lens 31 of a camera 30 (FIG. 4), such as a photographic or videographic camera, using a freely articulating mounting arm 5 (FIGS. 4-6), as described in more detail below. The filter assembly 1 is designed to therefore either be free-handed in front of the user's lens 31 or to be mounted in a free position giving the user full control of the angular position of the filter assembly 1 relative to the lens 31.

The handle mechanism may fit into the user's hand and may include finger holes 10 to allow the user to grip the handle mechanism. This provides the advantage of being able to allow the user to move the filter assembly 1 up-down, side-to-side, or in any other direction, thereby allowing the user to manipulate the angle at which a glass filter 29 inside the filter assembly 1 is positioned with respect to an exterior-facing element (e.g., the frontmost element of the lens 31) of the photographic or videographic lens 31. This free motion may give the user the ability to manipulate the direction of the light (image) as it reflects through the filter assembly 1 and enters the camera 30. This produces an optical effect that the user may adjust and control. Conventional fixed-position filters may not allow this type of control.

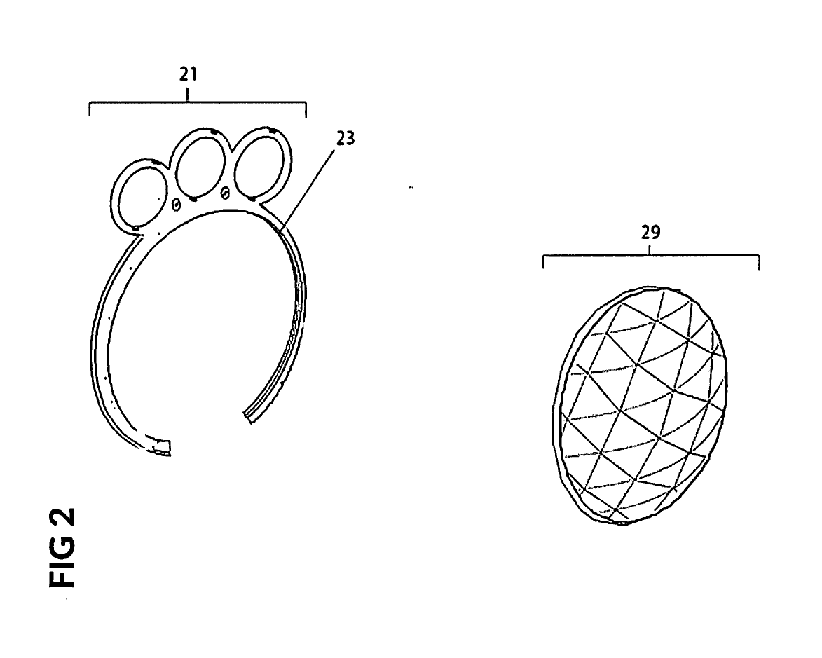

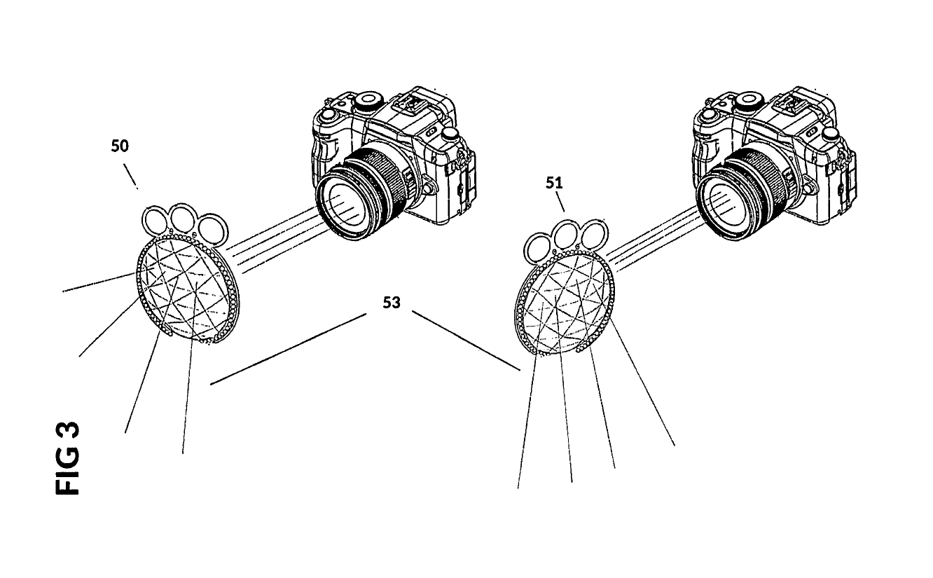

FIG. 2 shows an exploded view of the filter assembly 1. The filter assembly 1 may further include a polarizing inner-ring 25 which may be rotated with respect to the main housing unit 21 as the filter assembly 1 sits in the user's hand or on the mount, e.g., using the mounting arm 5 (FIGS. 4-6). The polarizing inner-ring 25 forms a snapping mechanism that allows the polarizing inner-ring 25 to sit inside the main housing unit 21. For example, the polarizing inner-ring 25 may include a protrusion 26 (FIG. 3) that snaps into a groove 23 in the inner-most face of the main housing unit 21. When attached, the engagement of the protrusion 26 in the groove 23 allows the polarizing inner-ring 25 to rotate freely with respect to the main housing unit 21, while preventing the polarizing inner-ring 25 from falling out of the main housing unit 21. The polarizing inner-ring 25 would have to be snapped out of the groove 23 to detach the polarizing inner-ring 25 from the main housing unit 21. The glass filter 29 may be shaped with multiple facets and may act as a prism to achieve the optical effects. The glass filter 29 may be locked into the polarizing inner-ring 25, e.g., with an adhesive.

As a result, the filter assembly 1 allows the glass filter 29 to move freely in front of the photo or videographic camera lens 31, thereby providing a changing optical effect. Being able to move the filter assembly 1 freely in front of the photo or videographic camera lens 31 provides the user with the ability to exploit the reflective properties of the glass filter 29 to create artistic optical effects.

FIG. 3 shows an exploded side profile of the filter assembly 1. The front portion of the polarizing inner-ring 25 may extend forward from the main housing unit 21. This extruded front portion on the polarizing inner-ring 25 may be formed withextruding bumps 26 that may allow easier gripping of the polarizing inner-ring 25 with the user's fingers to allow the user to rotate the polarizing inner-ring 25, and thus also the glass filter 29, as the polarizing inner-ring 25 sits within the main housing unit 21.

FIG. 4 shows an exploded view of the filter assembly 1 for mounting on the mounting arm 5. In a manner similar to the snap-in mechanism that allows attachment and detachment of the polarizing inner-ring 25 from the main housing unit 21, the mounting arm 5 may have one or more small stubs 6 (e.g., a circular stub), which may snap into the mounting holes 15 in the main housing unit 21 by applying a small amount of pressure with the user's fingers. The mounting arm 5 may be snapped out of the mounting holes 15 for detachment in the same way. This snap-in mechanism may be used to mount the filter assembly 1 to the mounting arm 5. The mounting arm 5 may be made of a flexible material such as copper, which may be molded into various shapes. Once shaped by the user, the mounting arm 5 may remain fixed with the same shape until further changed by the user. This may allow the filter assembly 1 to rotate, or move up-down, side-to-side, or in any other direction, and also to remain in the position set by the user in front of the exterior-facing element of the photographic or videographic lens 31.

The mounting arm 5 may have a mounting arm hotshoe 8 that allows the user to place flashes or other hotshoe controlled devices on top of the mounting arm 5. The mounting arm 5 may include an end unit that includes an adapter 9 that mount to the camera 30 by sliding the adapter 9 into a hotshoe 32 provided on the camera 30. Photographers and videographers may still want access to the hotshoe 32, which the mounting arm 5 may block when connected to the hotshoe 32. Therefore, the mounting arm hotshoe 8 may act as a ‘pass-through’ which allows photographers and videographers to retain full access to the hotshoe 32 while using the mounting arm 5. Thus, the mounting arm 5 may be mounted on top of the camera 30 by connecting the adapter 9 on the bottom of the end unit to the hotshoe 32.

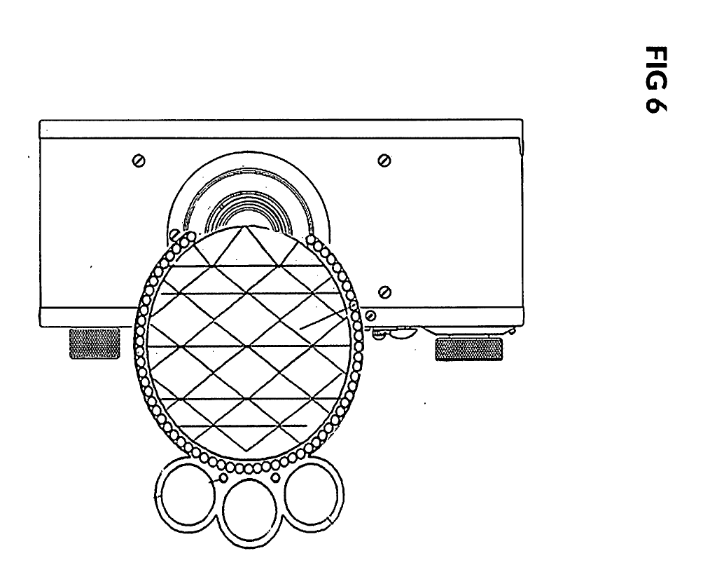

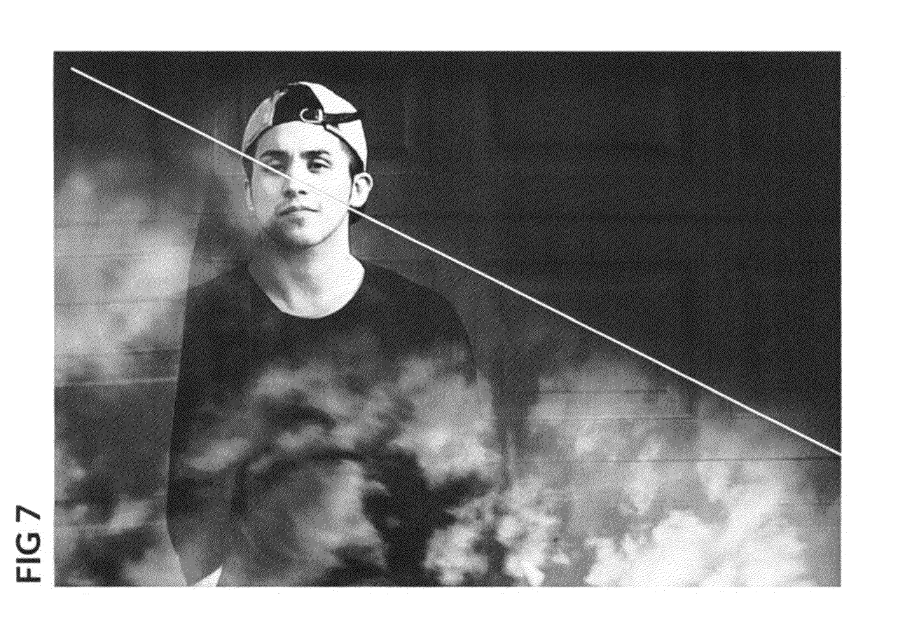

Alternatively, as shown in FIG. 5, the mounting arm 5 may be mounted on top of the camera 30 by using a mounting screw 7 that sits atop the end unit that includes the adapter 9. The mounting screw 7 may be a standardized screw that may engage with a screw hole on top of the camera 30, thereby allowing the user to mount the mounting arm 5 onto the camera 30 without using the hotshoe 32. In traditional DSLR cameras, this type of screw may be provided on the bottom of the camera 30. The mounting screw 7 may be useful for cameras that do not have a native hotshoe 32, like smaller cameras or video cameras. FIG. 6 shows that the mounting arm 5 may also be mounted on the bottom of the camera 30 by using the mounting screw 7 on the mounting arm 5. Thus, the mounting arm 5 may be mounted to the top or the bottom of the camera 30. The functionality of the two configurations is relatively similar; but users may have a preference between the two.

Although this description contains some significant detail, it should not be construed as limiting the scope of the invention but rather as providing illustrations of the preferred embodiments of the invention. For example, an alternative handle mechanism may be used in place of finger holes 10, such as a grip or a strap that attaches to the main housing unit 21. The finger holes 10 offer several advantages. The finger holes 10 may allow the handle mechanism to be smaller than other handle mechanisms, which may add convenience to the filter assembly 1 as smaller objects are easier to carry around. A smaller handle mechanism is also preferred because it may be less obtrusive while using the filter assembly 1 for photographic or videographic purposes. The finger holes 10 may wrap around the user's fingers, making it less likely that the user will drop and damage the filter assembly 1. Also, the main housing unit 21 may take a number of different shapes and is not limited to being circular.

1. An optical apparatus for use with a photographic or videographic camera uses, the optical apparatus comprising:
a filter assembly configured to affect the angular projection of light passing therethrough, via the combined use of a handle mechanism attached to the optical lens that is configured to be held by a user to position the filter assembly in a plurality of distances and angles with respect to the front of a camera lens of the camera, and an optical lens shaped for the purpose of bending light as it passes through the optical lens.
